(19) United States
(12) Patent Application Publication
(10) Pub. No.: US 2020/0315364 A1
(43) Pub. Date: Oct. 8, 2020

(54) Sheets and Coverings Retaining Device

(71) Applicant: James Joseph Tribble, Lisle, IL (US)

(72) Inventor: James Joseph Tribble, Lisle, IL (US)

(21) Appl. No.: 16/378,523

(22) Filed: Apr. 8, 2019

(51) Int. Cl. A47C 21/02; F16B 2/22

(52) U.S. Cl. CPC A47C 21/022; A47C 31/007; F16B 2/22

(57) ABSTRACT

A sheets and coverings retaining device is described which includes a top shell with a pressure bar affixed perpendicular to its surface and a bottom shell with a pressure bar affixed perpendicular to its surface wherein a sheet or other covering that is placed between the two shells is retained by the friction of the pressure bars making contact with the upper and lower shells when the shells are closed upon the sheet or covering.

### BACKGROUND

The present invention relates to keeping sheets or other coverings tucked. The inventor recognizes that a bed is often made with a tight, fitted sheet, as well as a loose top sheet. The inventor recognizes the desire for one's loose top sheet to remain tucked between a mattress and a boxspring. Often, before it is time to change the sheets, the loose top sheet becomes untucked. Sometimes this can happen in the middle of the night, and the bed must be completely re-made in the morning. The inventor has recognized that current solutions to the problem of keeping sheets tucked are inefficient and complicated.

### SUMMARY

An exemplary embodiment of the invention comprises a sheet retaining device that effectively secures sheets or other coverings in place on furniture, such as on beds. One embodiment of the invention provides a clamp-like device that retains the edges of a top sheet between a mattress and a boxspring. Further enhancements of the device include a pressure bar which adds retention to the sheet to keep it from slipping and a high friction material placed at pressure points to aid in the retention of the sheet. Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a side angled perspective view of an exemplary embodiment of the present invention in an open orientation.

FIG. 2 is a side angled perspective view of the embodiment of FIG. 1 in a partially closed orientation.

FIG. 3 is a cross-sectional side view taken generally along lines 3-3 of FIG. 2.

FIG. 4 is a front view of the embodiment of FIG. 2.

FIG. 5 is a side angled perspective view of an exemplary alternate embodiment of the present invention in a semi-collapsed compact position.

FIG. 6 is a front view of the embodiment of FIG. 5 in a substantially collapsed compact position.

FIG. 7 is a cross-sectional side view of the embodiment of FIG. 1 displayed at the foot of a bed in a first position for installation.

FIG. 8 is a side view of the embodiment of FIG. 1 displayed at the foot of a bed in a second position for installation.

FIG. 9 is a cross-sectional side view of the embodiment of FIG. 1 displayed at the foot of a bed in a third position for installation.

FIG. 10 is a cross-sectional side view of the embodiment of FIG. 1 displayed at the foot of the bed in a fourth position for installation.

FIG. 11 is a cross-sectional side view of the embodiment of FIG. 1 displayed at the foot of the bed in the final installed position.

FIG. 12 is a side angled perspective view of an exemplary second alternate embodiment of the present invention in an open orientation

FIG. 13 is a side angled perspective view of the embodiment of FIG. 12 in a partially closed orientation.

FIG. 14 is a cross-sectional side view of an exemplary third alternate embodiment of the present invention displayed at the foot of a bed in a first position for installation.

FIG. 15 is a cross-sectional side view of the further embodiment of FIG. 14 displayed at the foot of a bed in a second position for installation.

FIG. 16 is a cross-sectional side view of the embodiment of FIG. 14 displayed at the foot of a bed in a third position for installation.

FIG. 17 is a cross-sectional side view of the embodiment of FIG. 14 displayed at the foot of the bed in a fourth position for installation.

FIG. 18 is a cross-sectional side view of the embodiment of FIG. 14 displayed at the foot of the bed in a final installed position.

FIG. 19 is a side angled perspective view of the embodiment of FIG. 14 displayed in an open orientation.

FIG. 20 is a cross-sectional side view of an exemplary fourth alternate embodiment of the present invention.

FIG. 21 is a cross-sectional side view of an exemplary fourth alternate embodiment of the present invention with a sheet installed.

FIG. 22 is a cross-sectional side view of an exemplary fifth alternate embodiment of the present invention with a sheet installed.

FIG. 23 is a cross-sectional side view of an exemplary fifth alternate embodiment of the present invention.

FIG. 24 is a top-down angled perspective view of the embodiment of FIG. 23.

FIG. 25 is a top-down angled perspective view of the embodiment of FIG. 23.

FIG. 26 is a top-down angled perspective view of the embodiment of FIG. 20.

FIG. 27 is a top-down angled perspective view of the embodiment of FIG. 20.

FIG. 28 is a top-down angled perspective view of the embodiment of FIG. 20 in an open orientation and with a sheet installed.

FIG. 29 is a top-down angled perspective view of the embodiment of FIG. 23 in an open orientation and with a sheet installed.

FIG. 30 is a side angled perspective view of the embodiment of FIG. 1 in a bi-fold orientation.

FIG. 31 is a close-up side angled perspective view of the embodiment of FIG. 23.

FIG. 32 is a cross sectional view of an exemplary sixth alternate embodiment of the present invention.

FIG. 33 is a side angled perspective view of the embodiment of FIG. 32.

FIG. 34 is a side angled perspective view of an exemplary seventh alternate embodiment of the present invention in a semi-collapsed compact orientation.

FIG. 35 is a side angled perspective view of the embodiment of FIG. 32 with a sheet installed.

FIG. 36 is a front view of the embodiment of FIG. 34 in a substantially collapsed compact position.

FIG. 37 is a side angled perspective view of an exemplary eighth alternate embodiment of the present invention.

FIG. 38 is a front view of the embodiment of FIG. 34 in a partially open orientation.

FIG. 39 is a front angled perspective view of the embodiment of FIG. 32 in a partially open orientation.

FIG. 40 is a side angled perspective view of an exemplary ninth alternate embodiment of the present invention in a semi-collapsed compact orientation.

FIG. 41 is a top perspective view of the embodiment of FIG. 40 in a closed orientation.

FIG. 42 is a top view of the embodiment of FIG. 40 in a closed orientation.

FIG. 43 is a bottom view of the embodiment of FIG. 40 in a closed orientation.

FIG. 44 is a front view of the embodiment of FIG. 40 in a closed orientation.

FIG. 45 is a rear view of the embodiment of FIG. 40 in a closed orientation.

FIG. 46 is a left end view of the embodiment of FIG. 40 in a closed orientation, with the right end view being a mirror image.

FIG. 47 is a left end view of the embodiment of FIG. 40 in a closed orientation, shown holding a sheet that is shown dashed that does not form part of the claimed invention, with the right end view being a mirror image.

FIG. 48 is a side angled perspective view of an exemplary tenth alternate embodiment of the present invention in a closed, partially assembled orientation.

FIG. 49 is a top view of the embodiment of FIG. 48.

FIG. 50 is a cross sectional side view of the embodiment of FIG. 48.

FIG. 51 is a side angled perspective view of an exemplary embodiment of a part used to assemble the embodiment of FIG. 48.

FIG. 52 is a side view of the part of FIG. 51.

FIG. 53 is a top view of the part of FIG. 51.

FIG. 54 is a side angled perspective view of an exemplary embodiment of a part used to assemble the embodiment of FIG. 48.

FIG. 55 is a top view the embodiment of FIG. 54.

FIG. 56 is a bottom view of the embodiment of FIG. 54.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

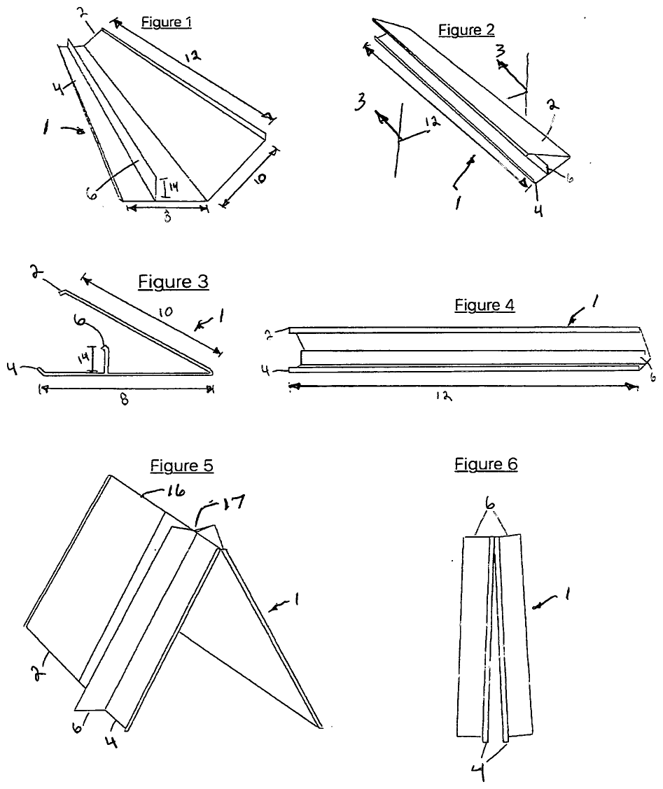

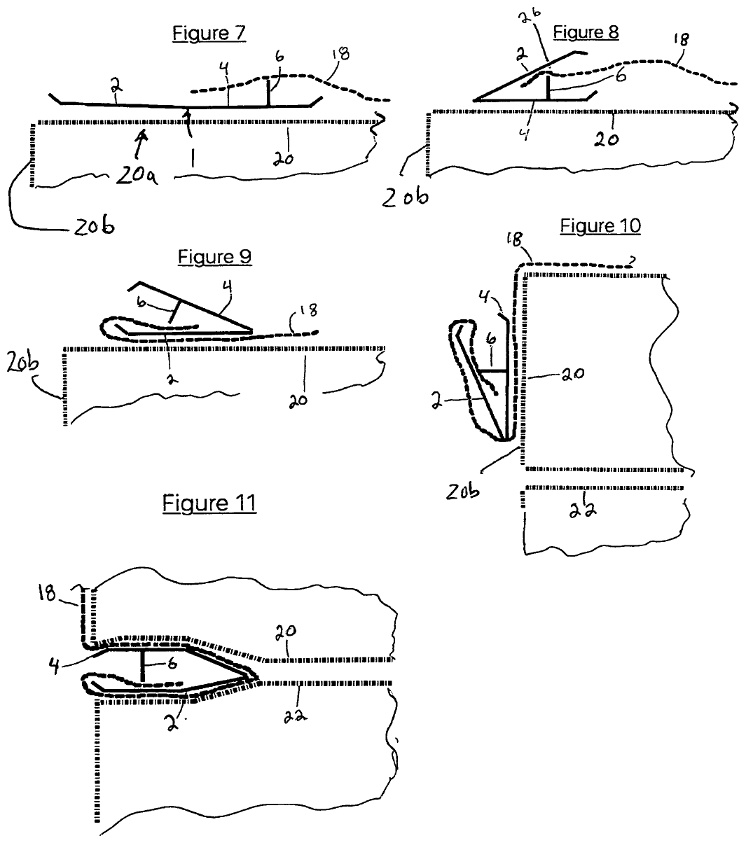

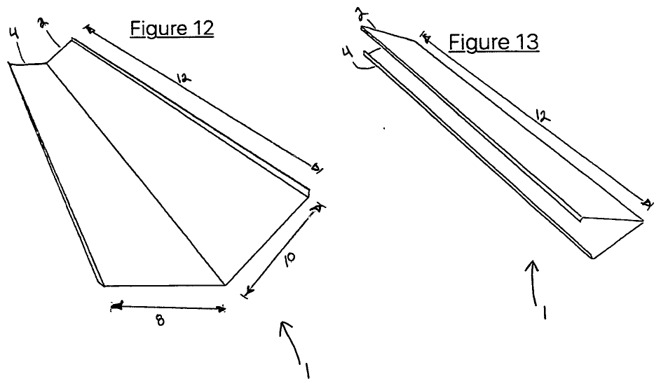

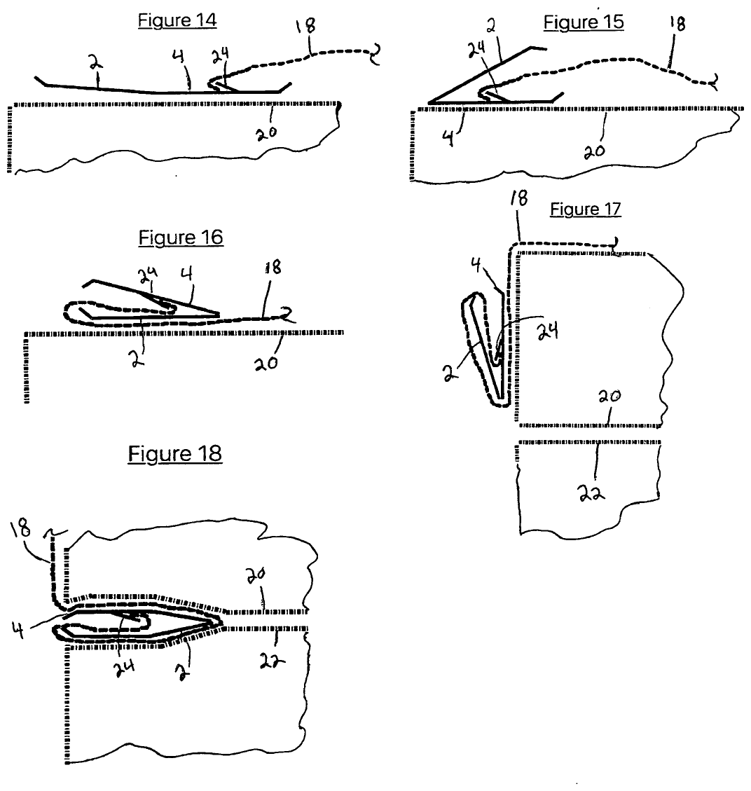

Exemplary embodiments in accordance with the present invention comprise a device for maintaining sheets or other coverings in a static position with regard to furniture, such as a bed. The device can comprise a body that folds down the middle lengthwise into two halves as shown in FIGS. 1-19.

An exemplary embodiment of the present invention includes a retainer 1 that can comprise a long folding piece of rigid material that is meant to keep a loose top sheet 18 held firmly between a mattress 20 and a boxspring 22 of a bed. The sheet is kept securely held between an upper shell 2 and a lower shell 4 of the retainer 1, with pressure applied to the sheet between the top of a pressure bar 6 and the upper shell 2 by the weight of the mattress or other object placed over the retainer 1. With the retainer 1 properly installed, the force from the weight of the mattress or other object which the embodiment is tucked between, would keep the sheets from coming free of the retainer 1 and firmly retained. An exemplary embodiment of the present invention has upper shell 2 and lower shell 4 made from one piece of rigid material which, at the folding point, is thinner so as to allow it to bend without breaking. An alternate embodiment of the present invention has upper shell 2 and lower shell 4 made from two pieces of rigid material which are attached at the folding point by a flexible material, such as rubber, glue, or a flexible plastic.

In an exemplary embodiment, the lower shell 4 has a width 8 approximately 3 inches wide, the upper shell has a width 10 approximately 3 inches wide, and the pressure bar has a height 14 approximately 1 inch tall. In an exemplary embodiment, the pressure bar's height and the upper and lower shell's widths have an approximate 1:3 ratio, and the pressure bar runs perpendicular to the inner surface of the lower shell 4.

In an exemplary embodiment, the retainer 1 has a length 12 that is the same length as the object being covered. For example, a king-sized bed is 72 inches wide and the optimal length 12 for a retainer 1 being used to keep the top sheet retained at the foot of such a king bed would be 72 inches long. Also, the standard hospital bed is 36 inches wide, and so an optimal length 12 for an embodiment for a hospital bed would be 36 inches long.

In an exemplary embodiment, the upper shell, lower shell, and pressure bar are made from a rigid yet flexible plastic. Alternate embodiments for the present invention include the upper shell, lower shell, and pressure bar being made from wood, metal or any other material suitable for the function of the present invention.

An alternate embodiment of the present invention includes a high-friction material, such as rubber, which would further aid in retaining the sheet or covering meant to be held static in accordance with the present invention. In such an embodiment, such high-friction material would be optimally placed between the upper 2 and lower 4 shells or between the upper shell 2 and the pressure bar 6 as in FIG. 8 at point 26.

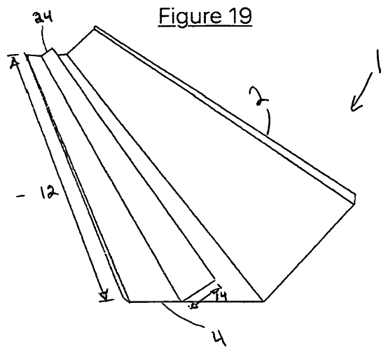

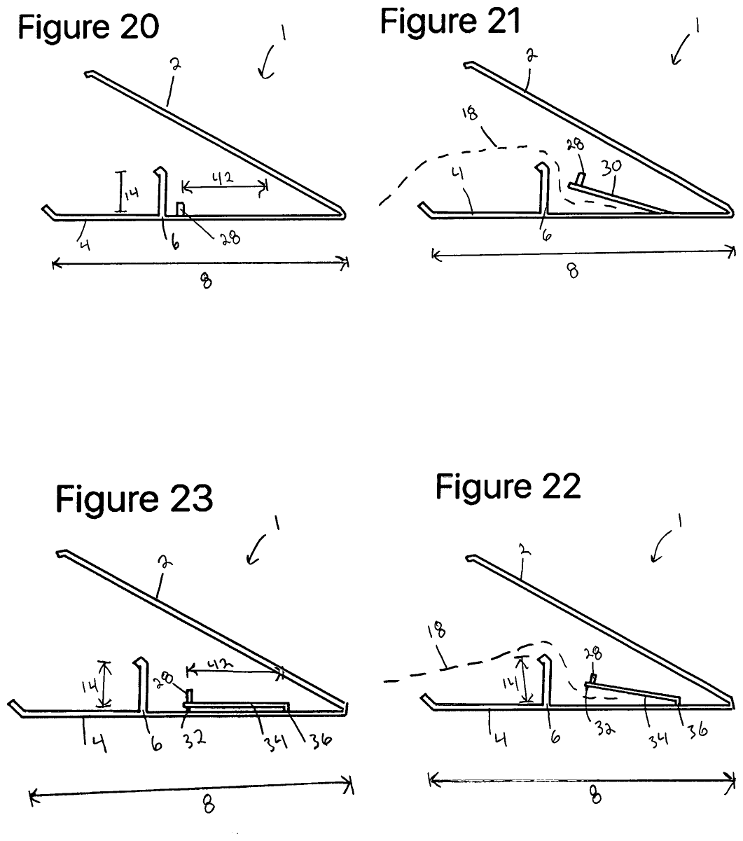

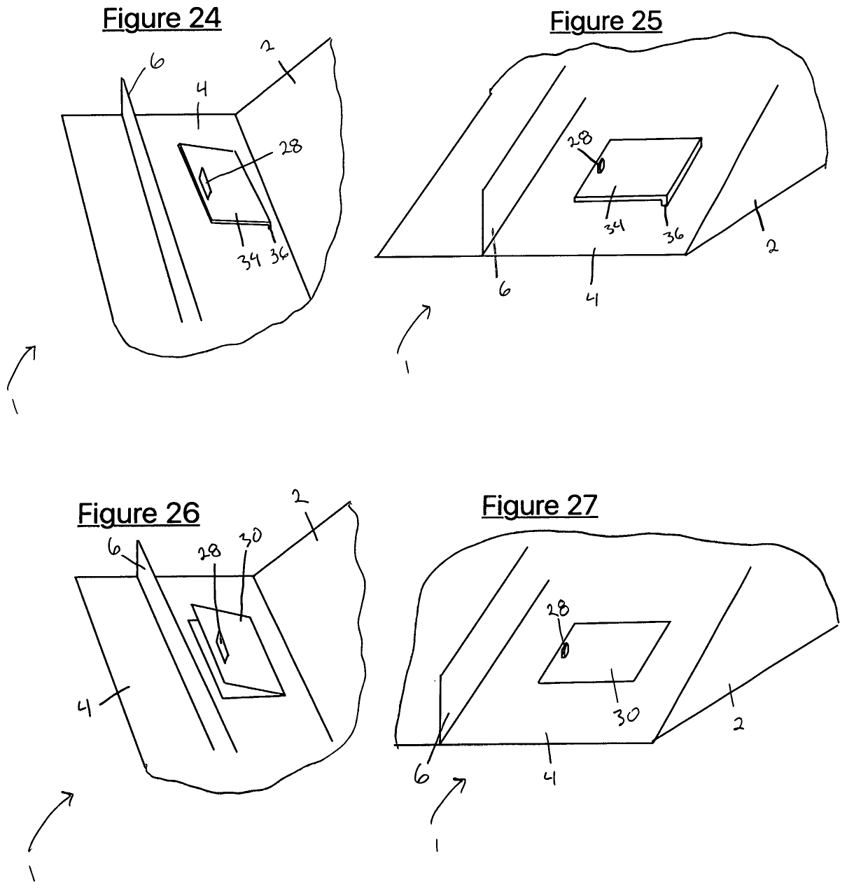

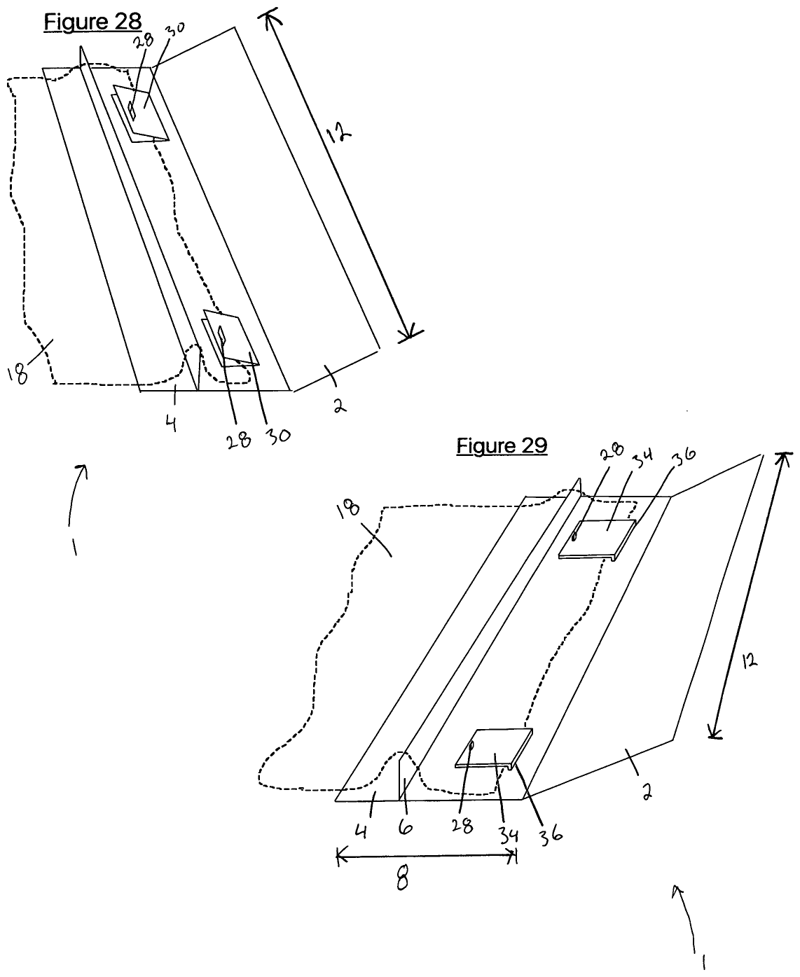

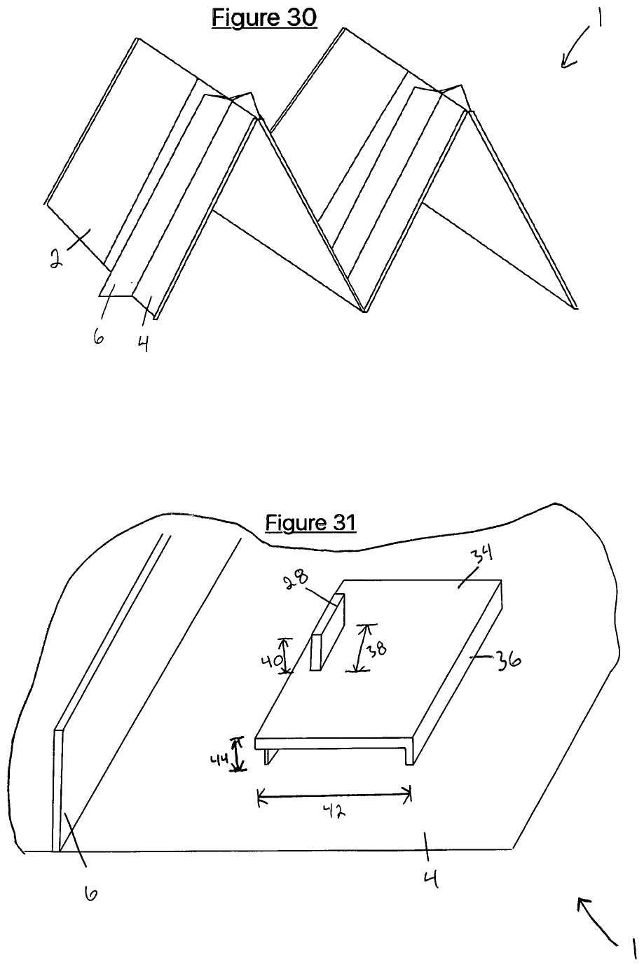

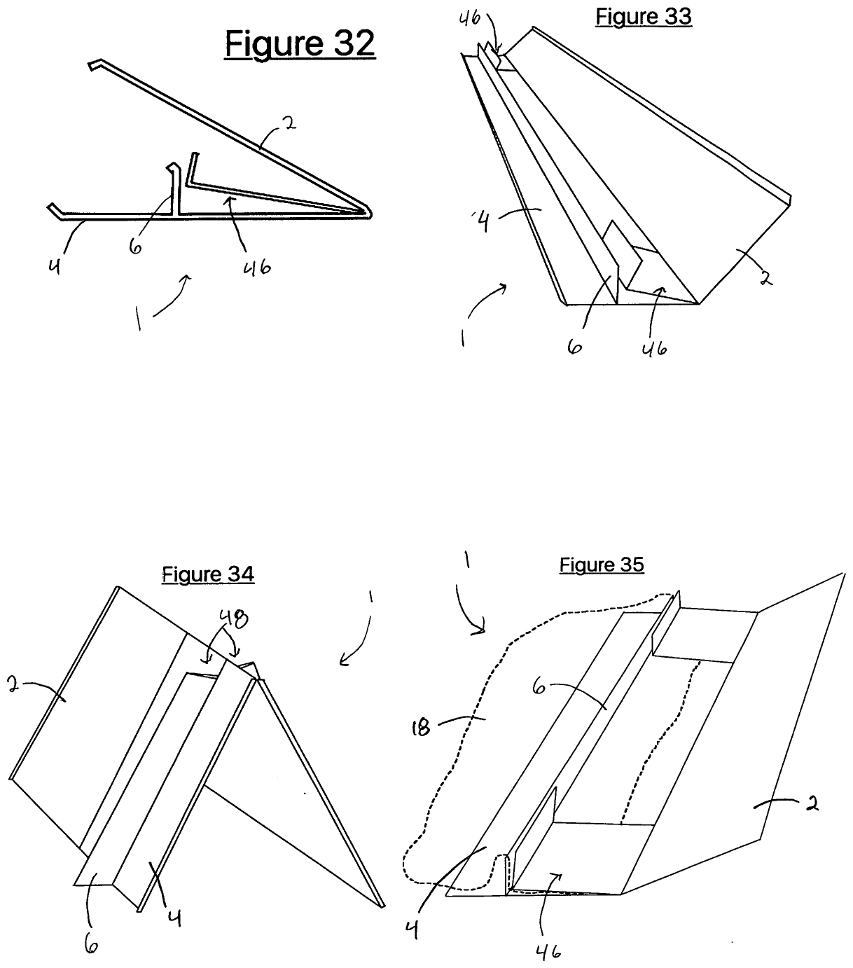

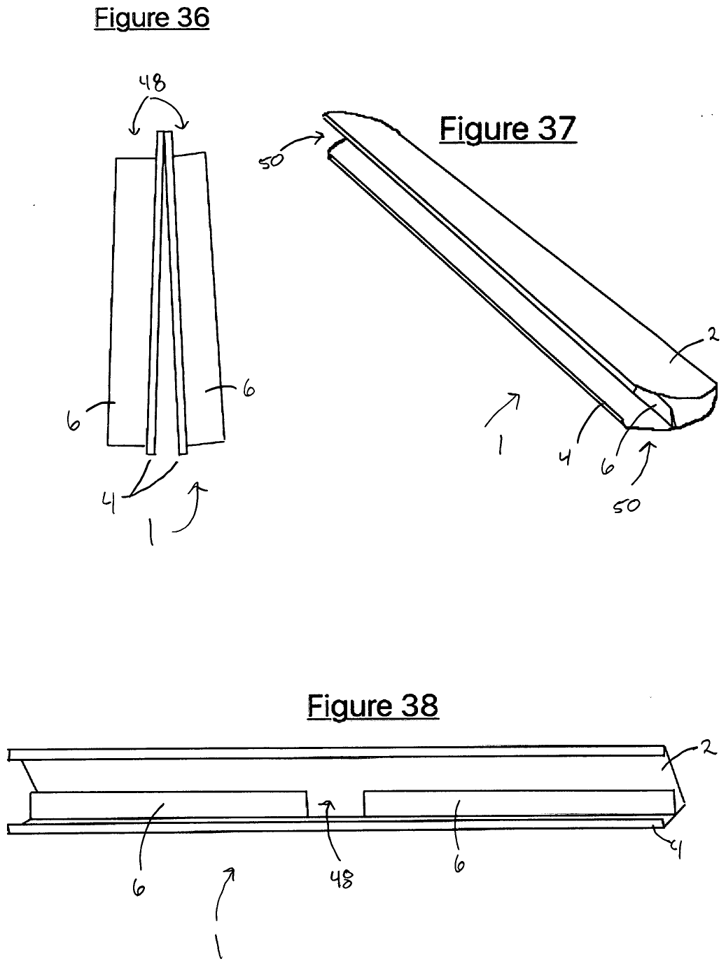

An alternate embodiment of the present invention includes a collapsible pressure bar 24 as in FIG. 19 and in FIG. 14 through FIG. 18. The sheet can be placed between the collapsible pressure bar 24 and the lower shell 4. By collapsible, it is meant that the bar 24 can fold down flush with the lower shell 4 when not in use. This is beneficial for providing a low profile retainer 1 for installation and during storage or shipping, and it can provide a greater pinching force by folding against an edge of the sheet when deployed.

An alternate embodiment of the present invention includes an upper shell 2, a lower shell 4, a pressure bar 6, and a trap door 30. The trap door 30 is cut from the lower shell 4, and aids in lining-up the covering on the embodiment for installation. The trap door 30 is lifted with the lifting tab 28 and the covering 18 is placed under the trap door 30. Once the lifting tab 28 is released, the tension between the trap door 30 and the lifting tab 28 will aid in retaining the covering while being installed.

An alternate embodiment of the present invention includes an upper shell 2, a lower shell 4, a pressure bar 6, and a mini retainer 34. The mini retainer 34 is held to the lower shell 4 by the mini retainer spine 36 and aids in lining-up the covering on the embodiment for installation. The mini retainer is lifted with the lifting tab 28 and the covering 18 is placed under the mini retainer 34. Once the lifting tab 28 is released, the pressure between the mini pressure bar 32 and the lower shell 4 will retain the covering while being installed.

Exemplary embodiments of the trap door 30 ad the mini retainer 34 have approximate width 42 of one inch. The length 38 and height 40 of an exemplary embodiment of the lifting tab 28 is approximately one half inch three fourths of an inch. An exemplary embodiment of the mini pressure bar 32 is flush with the lower shell 4. In an exemplary embodiment, the mini retainer spine 36 is not so tall 44 so as to interfere with the upper shell 2 and lower shell 4 from closing properly flush with the pressure bar 6.

An alternate embodiment of the present invention includes an upper shell 2 and a lower shell 4 but no pressure bar 6 as seen in FIGS. 12 and 13.

According to a further enhancement, the retainer 1 can fold widthwise down the middle into its compact form as in FIG. 5 and FIG. 6, for shipping purposes. A fold line 16 can be provided across the width of the upper and lower shells 2, 4 and a notch 17 is provided in the pressure bar 6 at the fold line 16. Thus a 72 inch long retainer can have a shipping length of 36 inches. An exemplary embodiment of the present invention has upper shell 2 and lower shell 4 made from one piece of rigid material which, at the fold line 16, is thinner so as to allow it to bend without breaking. An alternate embodiment of the present invention has upper shell 2 and lower shell 4 made from two pieces of rigid material each which are attached at the fold line 16 by a flexible material, such as rubber, glue, or a flexible plastic.

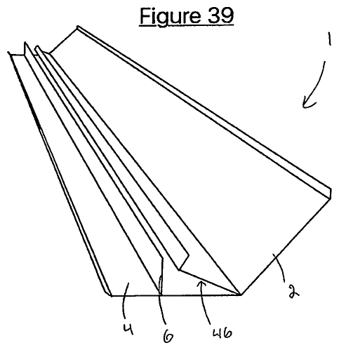

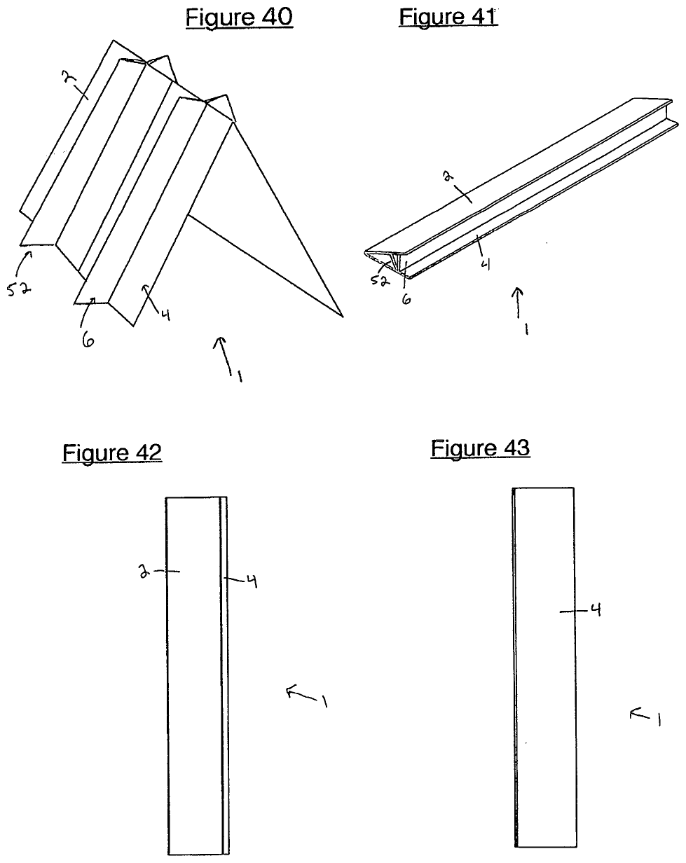

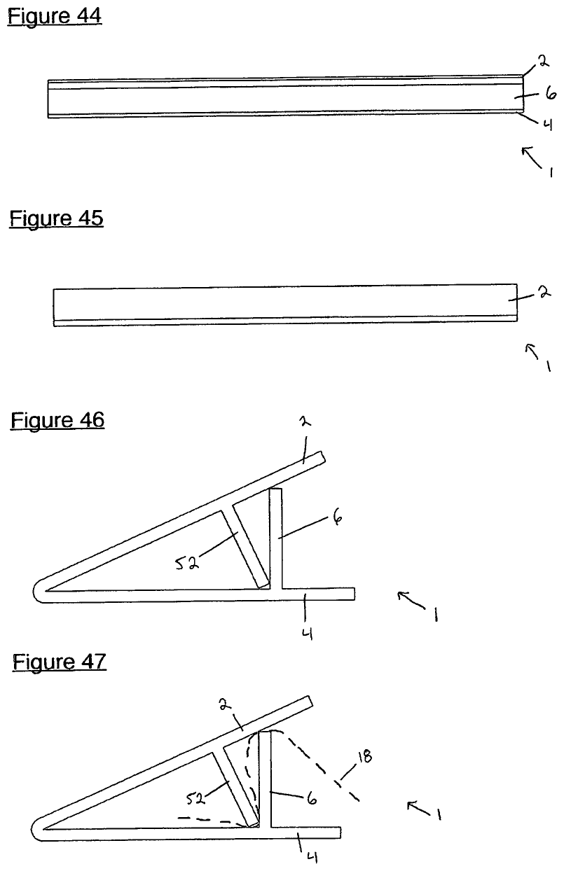

According to further enhancement, to prevent the sheet from slipping from its proper orientation between the upper shell 2 and pressure bar 6, an exemplary embodiment of the present invention includes two pressure flaps 46 at either end of the embodiment 1. When properly installed, the sheet or covering 18 is placed beneath the pressure flaps 46 before closing the upper shell 2 onto the pressure bar 6. An exemplary embodiment of the present invention 1 may have a singular pressure flap 46 running the entire length of the embodiment 1 as seen in FIG. 39 , or several smaller pressure flaps 46 placed at either end of the embodiment 1 as in FIG. 33.

According to further enhancement, an exemplary embodiment of the retainer 1 includes rounded edges 50 as seen in FIG. 37 and a pressure bar gap 48 as seen in FIG. 38. The pressure bar gap 48 serves to reduce the possibility of getting an object caught when transitioning the retainer 1 from its folded position to its installation position.

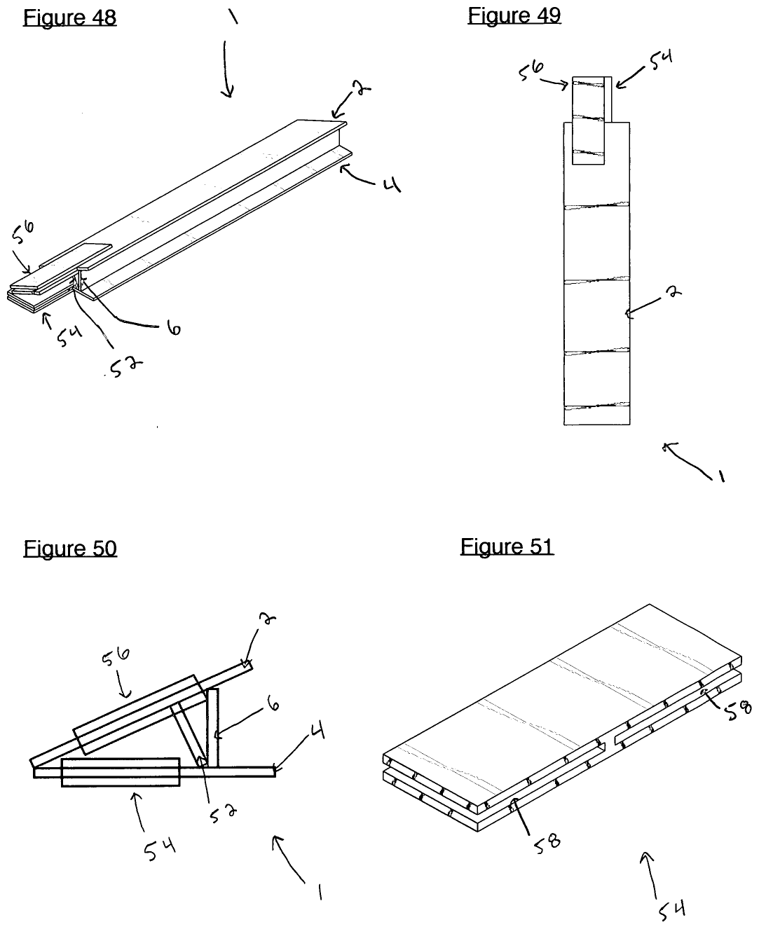

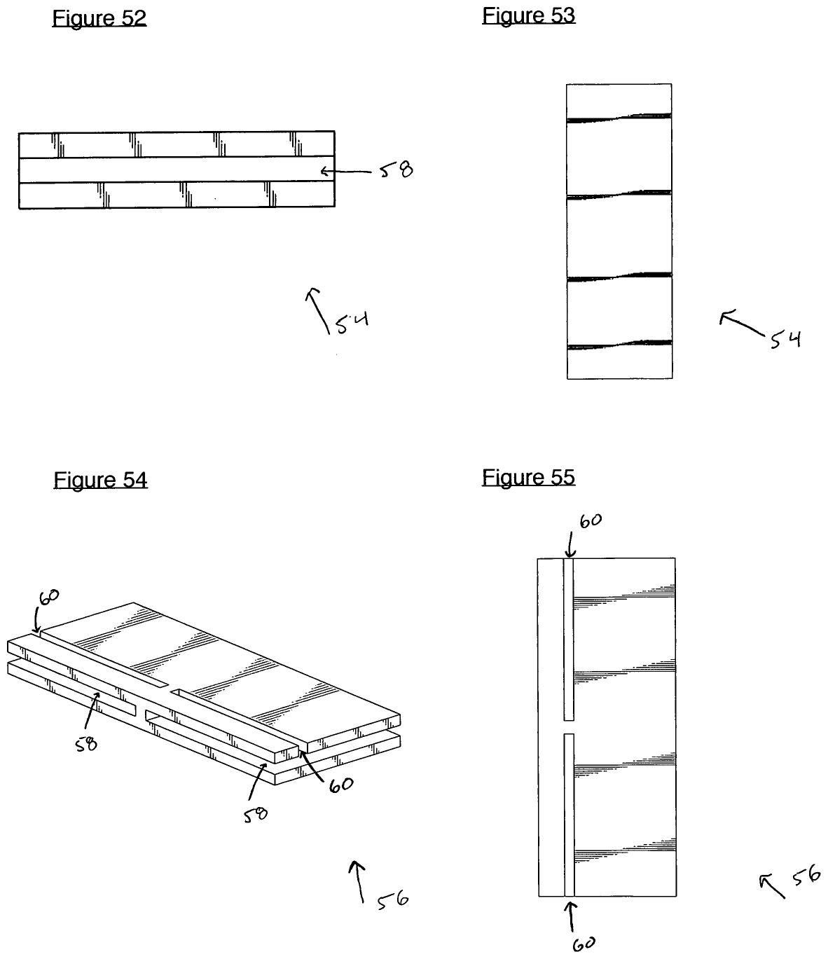

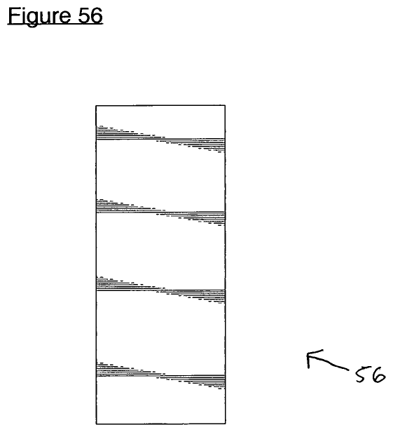

According to further enhancement, an exemplary embodiment of the retainer 1 includes a second pressure bar 52 attached to the upper shell 2. When the retainer 1 is in a closed orientation as in FIG. 47 the second pressure bar 52 provides pressure upon a sheet or covering 18 by trapping the sheet or covering 18 between the pressure bar 6 and the second pressure bar 52. According to further enhancement, an exemplary embodiment of retainer 1 includes rubberized coating added to the surface, tips, and/or edges of the pressure bars 6 and 52 as well as the upper shell 2 and lower shell 4 to add friction for enhanced retainment.

According to further enhancement, an exemplary embodiment of the retainer 1 includes upper clip 56 and lower clip 54 to connect two halves of retainer 1. The lower shell 4 slides into clip slot 58 of lower clip 54. The upper shell 2 slides into clip slot 58 of upper clip 56 as the second pressure bar 52 slides into pressure bar slot 60. Once both clips are attached as described, an exemplary partially assembled embodiment of retainer 1 can look as it does in FIG. 48. Then, a second retainer 1 can be added to the other end of the clips to assemble a longer embodiment. According to further enhancement, any number of retainers 1 can be attached end to end using embodiments of upper clip 56 and lower clip 54 to attain a desirable length.

The following examples are provided to illustrate various embodiments of the present systems, methods and components of the present inventions. These examples are for illustrative purposes, may be prophetic, and should not be viewed as limiting, and do not otherwise limit the scope of the present inventions.

a. Example 1: Someone who tosses and turns, often pulling their top sheet untucked during the night, installs the embodiment as described in FIGS. 7 through 11 in their bed to keep their sheets in place. In step 1 (FIG. 7) the user places the retainer 1 at a foot 20a of a mattress adjacent to the end vertical face 20b of the mattress with the upper shell closest to the face 20b and the sheet draped over the pressure bar 6. In step 2 (FIG. 8) the user folds the upper shell over the sheet and pressure bar 6, applying pressure manually so as to keep the sheet from slipping in a pinch area between the bar 6 and the upper shell 2. In step 3 (FIG. 9) the retainer 1 is rotated clockwise 180 degrees about an axis going into the page and pulled with the sheet toward the face 20b. In step 4 (FIG. 10) the retainer 1 along with the sheet is pulled further toward the face 20b and down along the vertical face 20b towards the boxspring. In the final step (FIG. 11) the retainer 1 and sheet are firmly tucked between the mattress and boxspring such that the retainer 1 is entirely between the two surfaces.
b. Example 2: Someone who prefers or requires a snug bedding installs one retainer 1 along the foot of the bed as well as additional retainers 1 along either side of the bed to clamp the edges of the sheet 18 along two or more edges to give themselves a tightly wrapped feeling during sleeping.
c. Example 3: A patient at a hospital who may be under the influence of medication and needs to lay still has their sheets tucked using retainers 1 along the foot of the hospital bed as well as along the sides of the bed to limit movement and possible accidental self-harm.
d. Example 4: A retainer 1 can be installed between couch cushions, as in example 1, wherein the couch replaces the mattress in the above description and the couch frame replaces the boxspring in the above description.

Although the retainer 1 described above has a lower shell and an upper shell that can be folded together to clamp a sheet therebetween, it is also encompassed by the invention that the lower shell and the upper shell can be separate pieces that can be engaged to or disengaged from each other using a snap fitting or other connection arrangement in order to selectively clamp the sheet therebetween.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present embodiments should not be limited to a particular embodiment, configuration or arrangement that is set forth in a particular embodiment, example, or in an embodiment in a particular Figure.

From the foregoing, it will be observed that numerous variations and modifications may be effected without departing from the spirit and scope of the invention. It is to be understood that no limitation with respect to the specific apparatus illustrated herein is intended or should be inferred.

1. A device for maintaining coverings in a fixed position, the device comprising a flat shell that folds down the middle lengthwise into two halves

2. The device of claim 1, further comprising a pressure bar which runs perpendicular to one half of the shell the entire length of the shell

3. The device of claim 1, further comprising two pressure bars which run perpendicular to each half of the shell the entire length of the shell

4. The device of claim 3, wherein the shell and pressure bars are able to further fold widthwise into a compact position

5. The device of claim 3, further comprising clip attachments allowing two modular halves to be made into one functional whole

6. The device of claim 1, further comprising high friction material at points of contact between the shell halves

7. The device of claim 1, wherein the covering is a sheet

8. The device of claim 1, wherein the covering is a blanket

9. The device of claim 1, wherein the covering is a non-woven sheet of material

10. A device for maintaining covering in a fixed position, the device comprising an openable shell, having means for gripping a covering within the shell

11. The device of claim 10, further comprising a pressure bar which runs perpendicular to one half of the shell the entire length of the shell

12. The device of claim 10, further comprising two pressure bars which run perpendicular to each half of the shell the entire length of the shell

13. The device of claim 12, wherein the shell and pressure bars are able to further fold widthwise into a compact position

14. The device of claim 12, further comprising clip attachments allowing two modular halves to be made into one functional whole

15. The device of claim 10, further comprising high friction material at points of contact between the shell halves

16. The device of claim 10, wherein the covering is a sheet

17. The device of claim 10, wherein the covering is a blanket

18. The device of claim 10, wherein the covering has antibacterial properties

19. The methods, examples and apparatus disclosed in the figures and specification of this application.
